(19) United States
(12) Patent Application Publication
(10) Pub. No.: US 2014/0237519 A1
(43) Pub. Date: Aug. 21, 2014

(54) CONTROL DEVICE AND CONTROL METHOD

(71) Applicant: Fujitsu Mobile Communications Limited, Kawasaki-shi (JP)

(72) Inventor: Isao MASUDA, Kawasaki (JP)

(73) Assignee: Fujitsu Mobile Communications Limited, Kawasaki-shi (JP)

(21) Appl. No.: 14/138,546

(22) Filed: Dec. 23, 2013

(30) Foreign Application Priority Data
Feb. 19, 2013 (JP) 2013-030444

(51) Int. Cl. H04N 21/422; H04N 21/214

(52) U.S. Cl. CPC H04N 21/42204; H04N 21/2143
USPC 725/80

(57) ABSTRACT

A device that controls devices in a network includes a storage unit configured to store registration information in which one or more pieces of identification information that identifies a device as a control target from among devices in the network are registered beforehand, and a processor configured to execute a process including detecting devices in the network from a response message in response to a device search message transmitted simultaneously to devices in the network and to extract a device whose identification information is registered in the registration information from among the detected devices, displaying the extracted device in a display device in a selectable manner, and performing a prescribed manipulation on a selected device when the processor detects that a user has selected one of the devices displayed in the display device.

### CROSS-REFERENCE TO RELATED APPLICATION

This application is based upon and claims the benefit of priority of the prior Japanese Patent Application No. 2013-030444, filed on Feb. 19, 2013, the entire contents of which are incorporated herein by reference.

### FIELD

The embodiments discussed herein are related to a control device, a control method, and a recording medium having stored therein a program that control a device in a network.

### BACKGROUND

Home networks, which can transmit and receive multimedia data by connecting in a wired or wireless manner devices such as televisions, personal computers, digital video recorders, etc., that were produced in accordance with the standard of Digital Living Network Alliance (DLNA) guidelines, have conventionally been known.

In relation to the above technique, a control method that facilitates the determination of a linkage function of a plurality of devices connected to a local area network has been known. In accordance with the selection of a device by a user, a control unit that performs this control provides a display device with data representing linkage operations that can be executed by the device selected by the user.

Also, a network device discrimination management system that can correctly select a target network device in accordance with an external view displayed in a screen is known. This network device discrimination management system manages network devices connected through a network so that images picked up by an image pickup device connected to the network are associated by a main management device with pieces of unique identification information that are uniquely assigned to the respective network devices connected through the network. Then, the network device discrimination management system determines a network device by unique identification information extracted from an image file.

Also, an information processing device realizing a configuration that enables easy recognition of correspondence relationships between devices on a device list and actual devices that are connected to a network is known. This information processing device registers a device image obtained by picking up an image of a device as an icon for a device list and thereby can reliably recognize an actual device in accordance with an icon on the device list.

Patent Document 1: Japanese Laid-open Patent Publication No. 2003-022224

Patent Document 2: Japanese Laid-open Patent Publication No. 2009-100217

Patent Document 3: Japanese Laid-open Patent Publication No. 2010-026964

### SUMMARY

According to an aspect of the embodiments, a control device that controls devices in a network includes a storage unit configured to store registration information in which one or more pieces of identification information that identifies a device as a control target from among devices in the network are registered beforehand, and a processor configured to execute a process including detecting devices in the network from a response message in response to a device search message transmitted simultaneously to devices in the network and to extract a device whose identification information is registered in the registration information from among the detected devices, displaying the extracted device in a display device in a selectable manner, and performing a prescribed manipulation on a selected device when the processor detects that a user has selected one of the devices displayed in the display device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an outline of a home network 100 including a digital media controller 110 that implements a control device according to the present example;

FIG. 2 illustrates an example of a process of manipulating a server 131 and a renderer 141 from the digital media controller 110;

FIG. 3 illustrates an example of the digital media controller 110;

FIG. 4 illustrates an example of the server 131;

FIG. 5 illustrates an example of the renderer 141;

FIG. 6 illustrates an example of a configuration of a device information list 600 including device information according to the present example;

FIG. 7 illustrates an outline of a process of registering a device in the device information list 600;

FIG. 8 is a flowchart illustrating an example of a process of registering device information in the device information list 600;

FIG. 9 illustrates an application example of the device information list 600;

FIG. 10 illustrates an example of a device information list when the list is shared by controllers 910 and 920;

FIG. 11 illustrates an example of a process in which a device information list is shared by the controllers 910 and 920;

FIG. 12 illustrates an outline of a device search that uses mobile-device-particular information;

FIG. 13 is a flowchart illustrating an example of a process of device search that uses mobile-device-particular information;

FIG. 14 illustrates an outline of content search that uses mobile-device-particular information;

FIG. 15A is a flowchart illustrating an example of a process of content search that uses mobile-device-particular information;

FIG. 15B is a flowchart illustrating an example of a process of content search that uses mobile-device-particular information;

FIG. 16 illustrates an outline of a process that performs device search and content reproduction by using an image picked up by a camera;

FIG. 17A is a flowchart illustrating an example of a process that performs device search and content reproduction by using an image picked up by a camera; and

FIG. 17B is a flowchart illustrating an example of a process that performs device search and content reproduction by using an image picked up by a camera.

### DESCRIPTION OF EMBODIMENTS

<Consideration by Inventor>

In, for example, linkage between devices in a home network, an accumulation device (server) and a display device (renderer/player) of content are managed by character strings representing the names of those devices. Accordingly, when the number of devices has increased, it is difficult for a user to determine a desired device on a list on which devices existing in a home network are displayed.

Also, for example, a device in a home network can be recognized by a response message transmitted in response to a device search message that was transmitted simultaneously to all devices in the home network. However, it is difficult to know at what position the thus-recognized device is arranged in, i.e., for example, whether or not the thus-recognized device is the device existing in front of the user, etc.

Accordingly, there is a problem in which, for example, it is not possible for a user to search for content stored in a desired device from among devices in a home network or to specify the device to display that content.

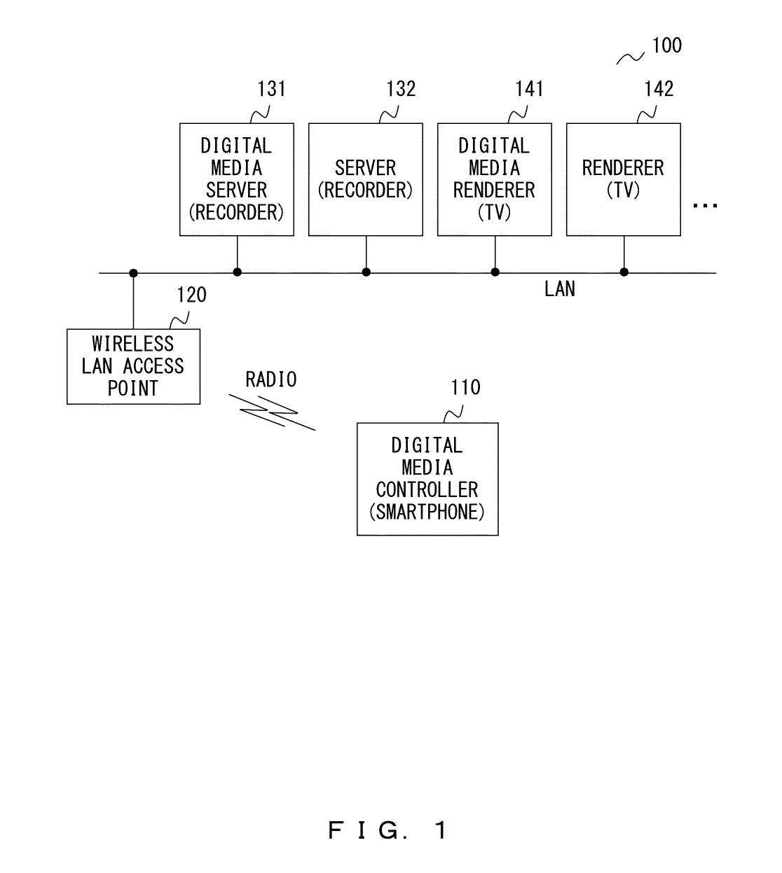

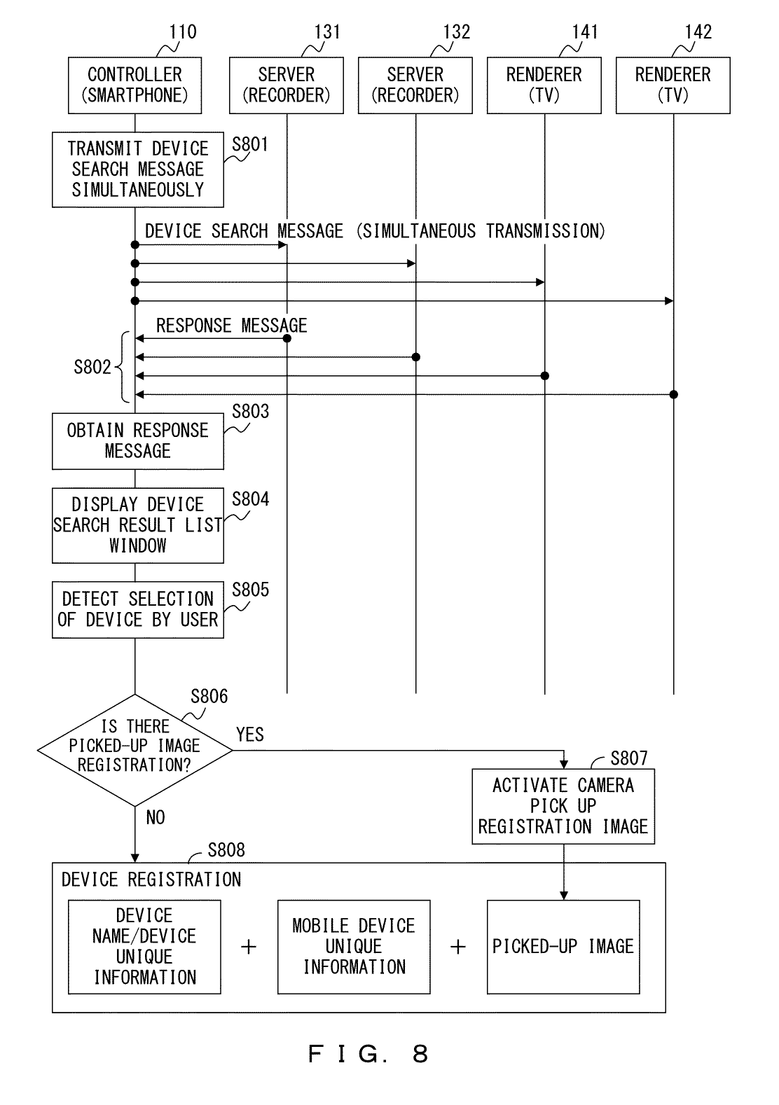

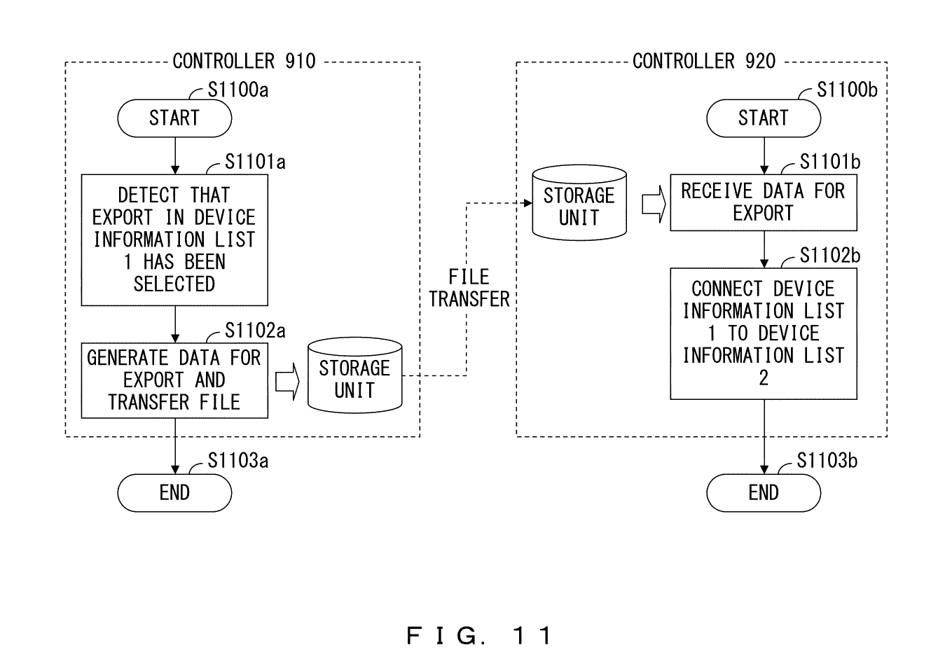

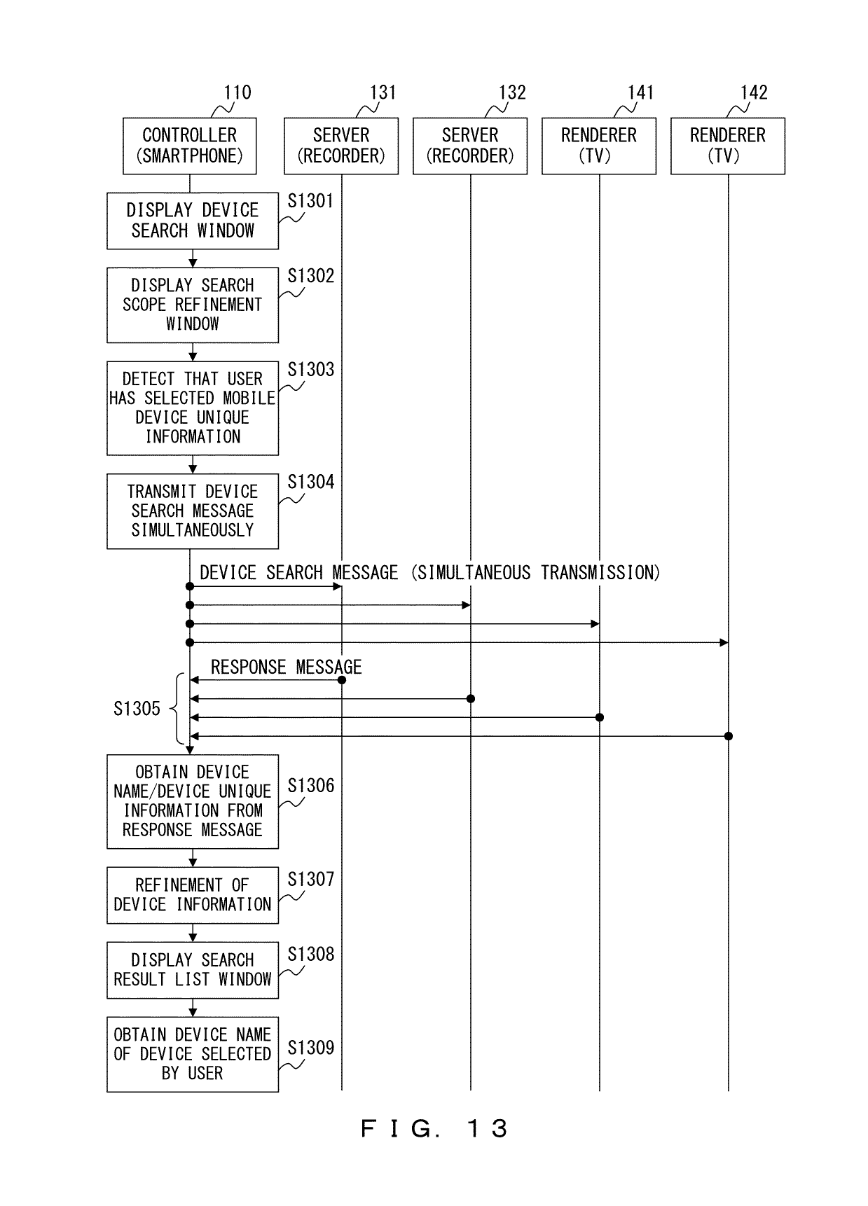

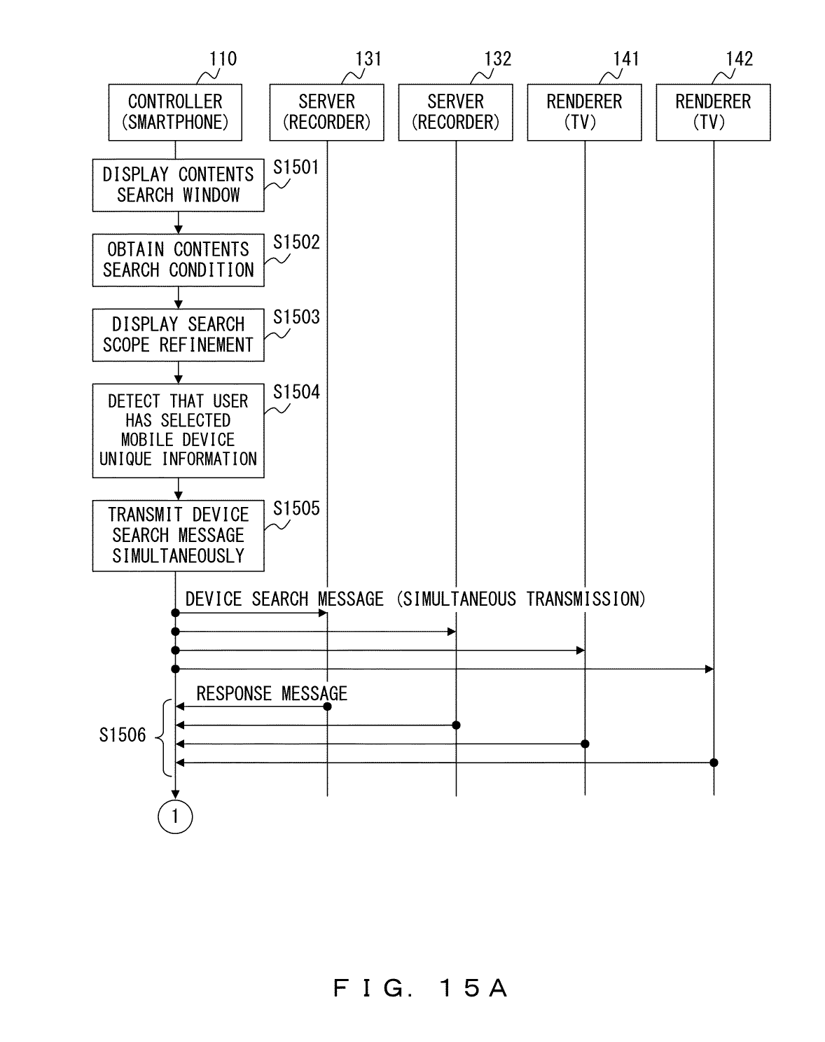

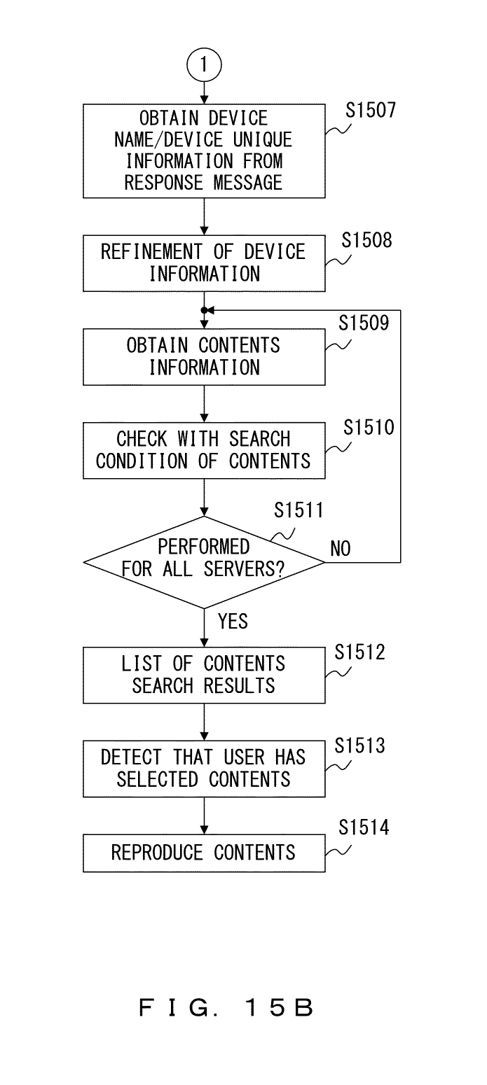

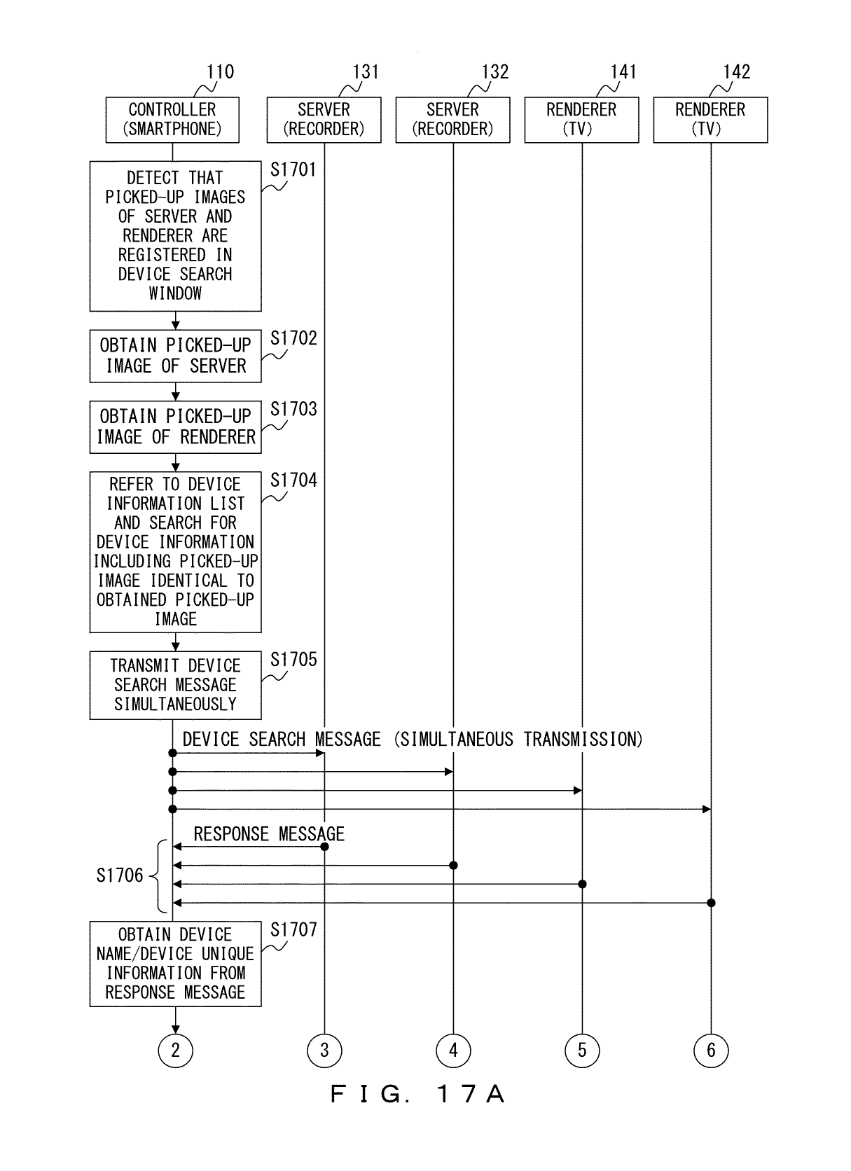

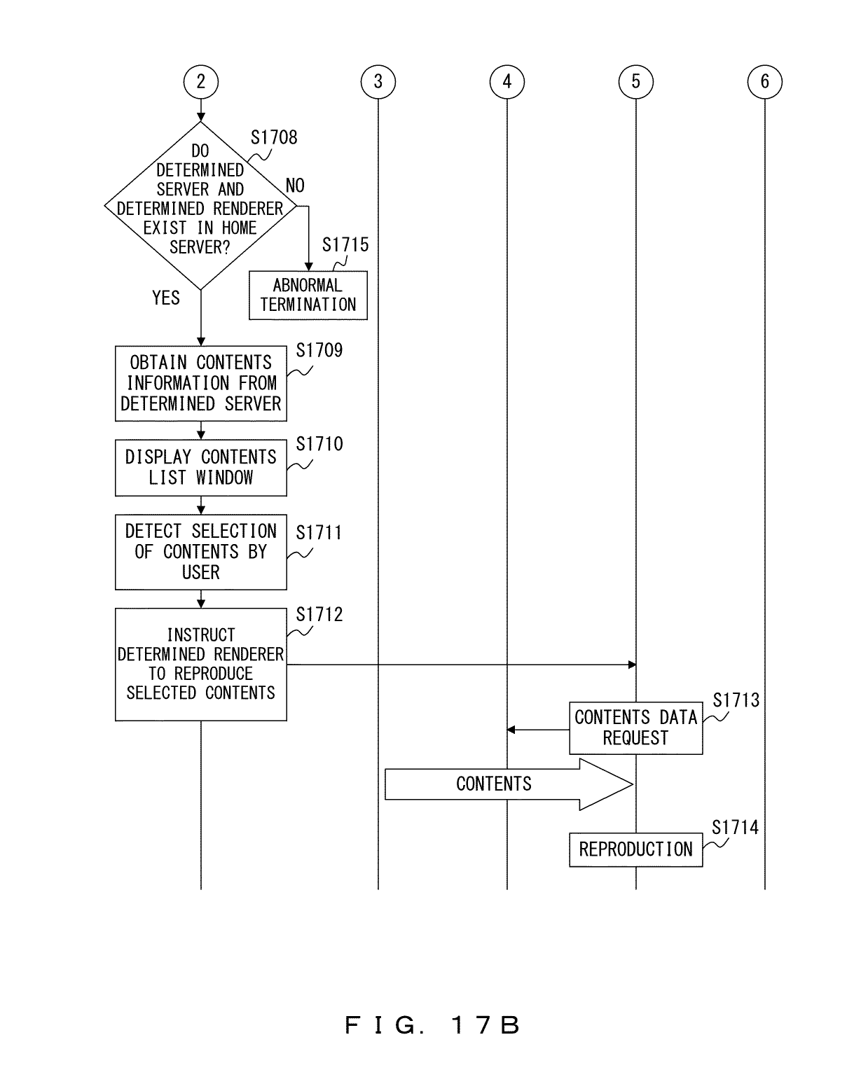

Hereinafter, an example of embodiments of the present invention will be explained by referring to FIG. 1 through FIG. 17B. Note that the embodiments explained below are examples and are not intended to exclude the application of various alterations or techniques that are not described below. In other words, the present embodiments can be embodied with various alterations, such as combinations of techniques included in the examples or other techniques, without departing from the spirit. Also, the processes represented in the form of flowcharts in FIG. 8, FIG. 11, FIG. 13, FIG. 15A, FIG. 15B, FIG. 17A, and FIG. 17B are not intended to limit the order of processes. Accordingly, it is natural that the order of processes may be changed.

### EXAMPLES

FIG. 1 illustrates an outline of a home network 100 including a digital media controller 110 that realizes a control device according to the present example.

The home network 100 includes the digital media controller 110, a wireless LAN access point 120, digital media servers 131 and 132, and digital media renderers 141 and 142. The digital media controller 110, the digital media servers 131 and 132, and the digital media renderers 141 and 142 can include functions based on the specification of the DLNA guidelines.

The digital media controller 110 performs the control of the servers 131 and 132 and the renderers 141 and 142 via the wireless LAN access point 120. For example, the digital media controller 110 searches for content stored in the digital media servers 131 and 132, and instructs the digital media renderer 141 or 142 to render (reproduce) the content in response to a request from a user. For the digital media controller 110, a mobile terminal device such as a smartphone can be used for example. Note that while FIG. 1 includes the text “smartphone” as an example of the digital media controller 110, this is not intended to limit the digital media controller 110 to a smartphone.

The digital media servers 131 and 132 store content such as recorded TV programs, etc. Also, in response to a request, the digital media servers 131 and 132 distribute content to the digital media renderers 141 and 142 connected to the network. For the digital media servers 131 and 132, an accumulation device that accumulates digital information such as a digital video recorder or the like maybe used for example. Note that while FIG. 1 illustrates two digital media servers 131 and 132 as examples, it is not intended to limit the number of digital media servers included in the home network 100. Also, FIG. 1 includes the text “recorder” as an example of the digital media servers 131 and 132, and this means a digital video recorder. However, it is not intended to limit the digital media server 131 or 132 to a digital video recorder.

The digital media renderers 141 and 142 render (reproduce) content obtained from the digital media server 131 or 132 in accordance with an instruction from the digital media controller 110. The digital media renderers 141 and 142 may use a device having a function of reproducing digital information, such as for example, a television (TV), a personal computer (PC), etc. Also, while FIG. 1 includes the text “TV” as an example of the digital media renderers 141 and 142, it is not intended to limit the digital media renderers 141 and 142 to a TV.

The digital media controller 110 may include the functions of the digital media servers 131 and 132 and the renderers 141 and 142.

In the explanations below, a digital media controller is simply referred to as a “controller”. Also, a digital media server is simply referred to as a “server”. Further, a digital media renderer is simply referred to as a “renderer”. Also, if necessary, servers such as the servers 131 and 132 are collectively referred to as “servers 130”, and renderers such as the renderers 141 and 142 are collectively referred to as “renderers 140”.

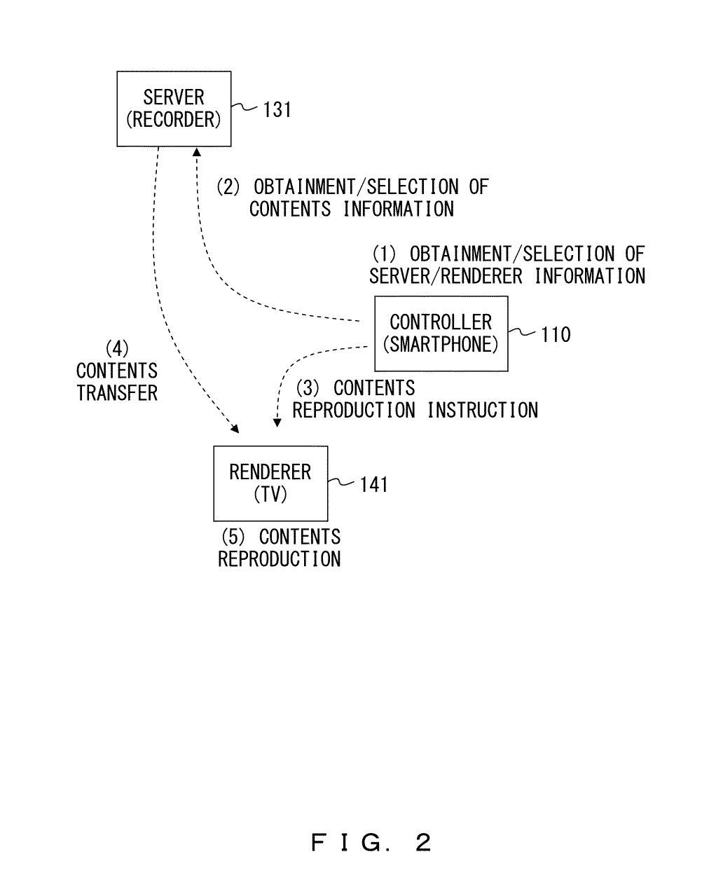

FIG. 2 illustrates an example of a process of manipulating the server 131 and the renderer 141 from the controller 110. FIG. 2 illustrates as an example a process in which the controller 110 makes the renderer 141 reproduce content in the server 131. “(1)” through “(5)” in FIG. 2 correspond to “(1)” through “(5)” below.

(1) The controller 110 obtains information about servers and renderers existing in the home network 100. The controller 110, for example, transmits a device search message simultaneously to all devices in the home network 100, and can recognize servers and renderers in the home network 100 on the basis of responses to the transmitted message. When the controller 110 has obtained information about servers and renderers in the home network 100, the controller 110 displays a list of obtained servers and renderers in a selectable manner on a display panel 340, which will be explained later.

(2) When a user has selected a desired server and a renderer, the controller 110 obtains content information from the server 131 selected by the user. Then, the controller 110 displays, on the display panel 340 in a selectable manner, a list of content included in the obtained content information.

(3) When the user has selected content, the controller 110 instructs the renderer 141 selected by the user in (1) to reproduce the content that were selected by the user and stored in the server 131.

(4) When the renderer 141 has received an instruction to reproduce the content from the controller 110, the renderer 141 requests from the server 131 the content for which the reproduction instruction was made. Then, the server 131 transfers to the renderer 141 the content requested by the renderer 141.

(5) When the content for which the reproduction instruction was made by the controller 110 has been transferred from the server 131, the renderer 141 reproduces the transferred content.

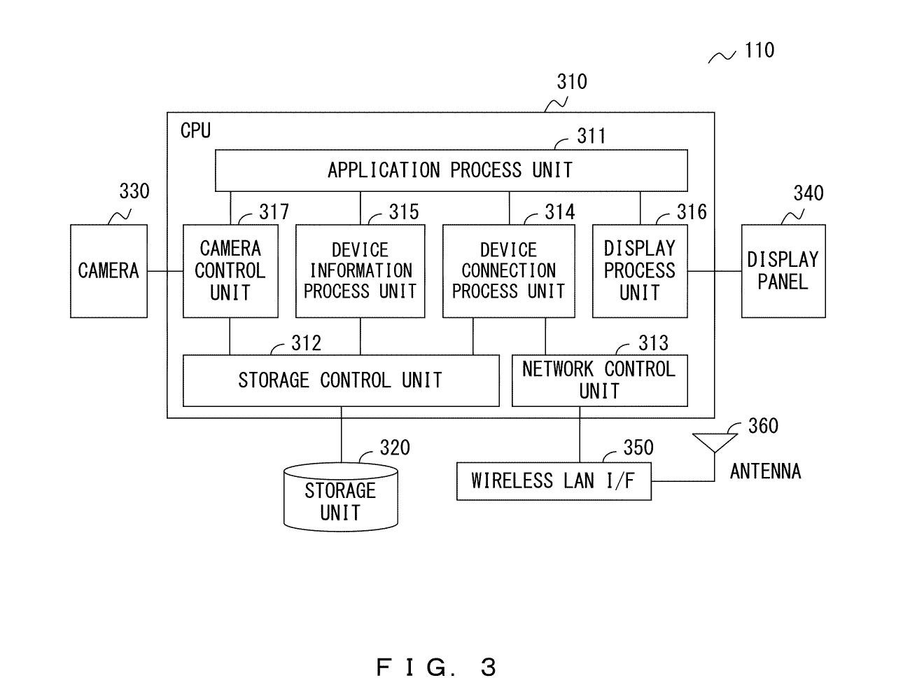

FIG. 3 illustrates an example of the controller 110.

The controller 110 may include a central processing unit (CPU) 310, a storage unit 320, a camera 330, the display panel 340, a wireless LAN interface (I/F) 350, and an antenna 360.

The CPU 310 may be, for example, a processor. The CPU 310 controls constituents included in the controller 110 so that the controller 110 operates, and also realizes control according to the present example by executing a prescribed program. Specifically, the CPU 310 may realize an application process unit 311, a storage control unit 312, a network control unit 313, a device connection process unit 314, a device information process unit 315, a display process unit 316, a camera control unit 317, etc., in accordance with, for example, a prescribed program.

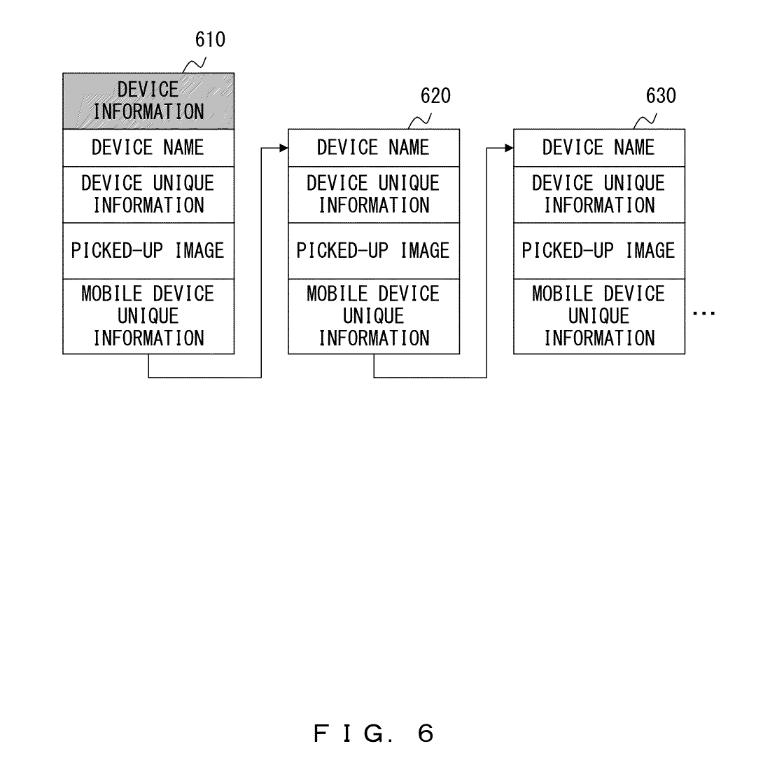

The application process unit 311 may perform control according to the present example by manipulating, for example, the device connection process unit 314, the device information process unit 315, the display process unit 316, the camera control unit 317, etc., in accordance with a prescribed program included in application software. The storage control unit 312 reads data from and writes data to the storage unit 320 in accordance with a request from the application process unit 311, the device information process unit 315, the camera control unit 317, and the like. The network control unit 313 transmits data to and receives data from a device in the home network 100 by using the wireless LAN interface (I/F) 350. The device connection process unit 314 transmits data to and receives data from the server 131 and the renderer 141 in accordance with a prescribed protocol. The device information process unit 315 manages a device information list 600, which will be described later in FIG. 6, stored in the storage unit 320. For example, the device information process unit 315 performs a process of registration, modification, and deletion of device information in the device information list 600, searches for desired device information from the device information list 600 registered in the storage unit 320, and performs other processes, in response to the request from the application process unit 311.

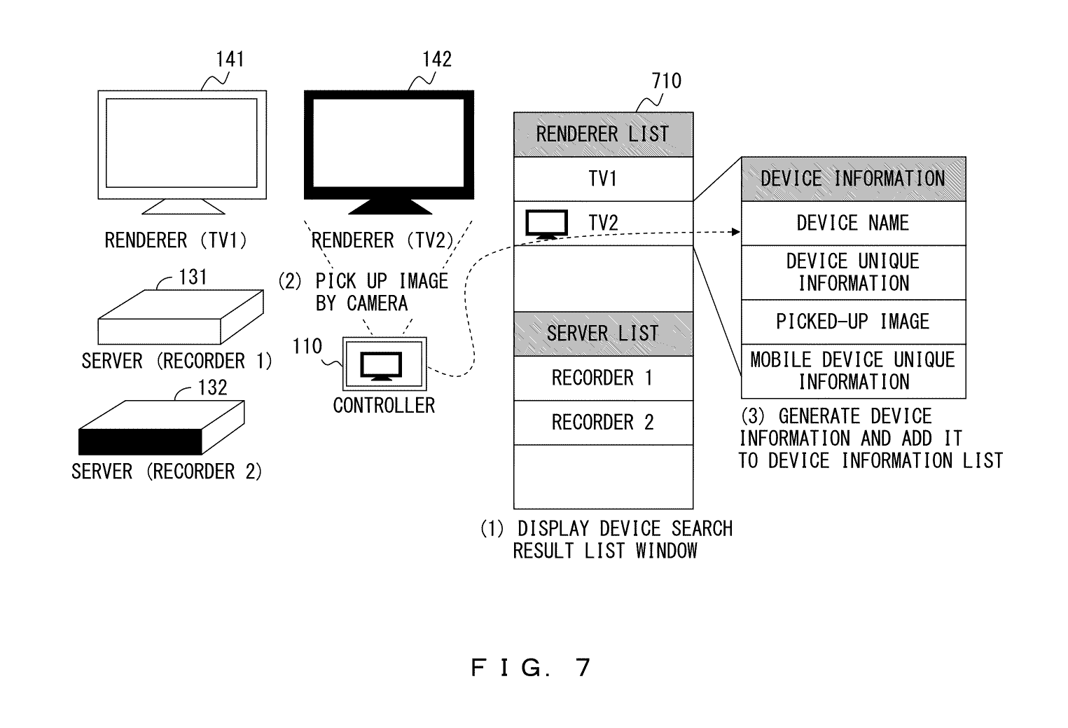

The display process unit 315 displays, for example, a device search result list window 710, which will be described in FIG. 7, on the display panel 340 in accordance with an instruction from the application process unit 311. The camera control unit 316 controls the camera 330, and picks up an image of the server 131, the renderer 141, or the like so as to generate a picked-up image.

The storage unit 320 is a storage device that stores data. For the storage unit 320, a non-volatile memory such as a magnetic disk storage device may be used.

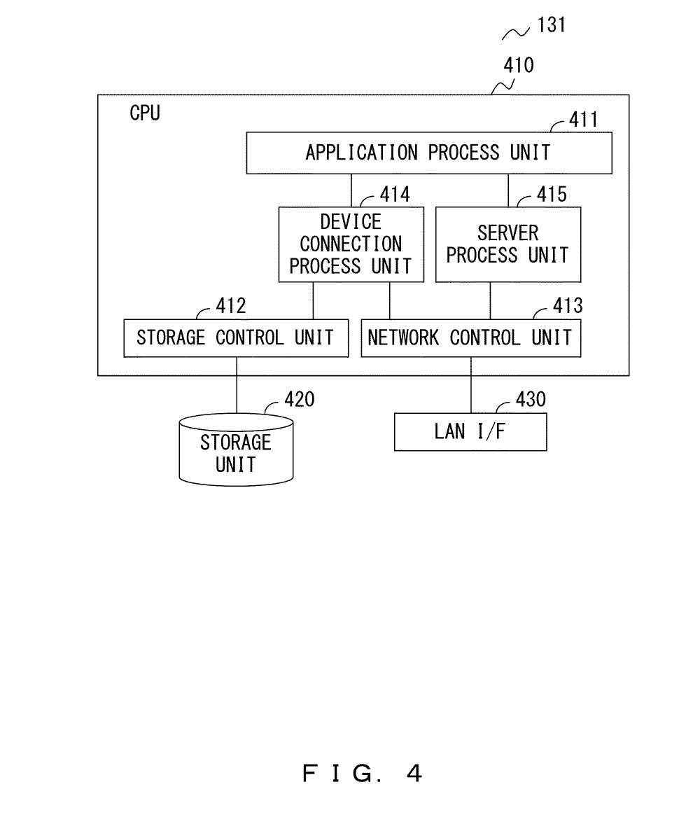

FIG. 4 illustrates an example of the server 131. The server 132 can be in a configuration similar to that of the server 131, and accordingly explanations of the server 132 will be omitted.

The server 131 may include a CPU 410, a storage unit 420, and a LAN I/F 430.

The CPU 410 maybe, for example, a processor. The CPU 410 controls constituents included in the server 131 so that the server 131 operates. Specifically, the CPU 410 realizes an application process unit 411, a storage control unit 412, a network control unit 413, a device connection process unit 414, a server process unit 415, etc., in accordance with a prescribed program.

The application process unit 411 may manipulate the storage control unit 412, the network control unit 413, the device connection process unit 414, the server process unit 415, etc., in accordance with a prescribed program included in application software. The storage control unit 412 reads data from and writes data to the storage unit 420 in response to a request from the application process unit 411, the device connection process unit 414, etc. The network control unit 413 transmits data to and receives data from a device in the home network 100 by using the wireless LAN interface (I/F) 350. The device connection process unit 414 transmits data to and receives data from the controller 110 and the renderer 141, etc., in accordance with a prescribed protocol. The server process unit 415 transfers information such as content stored in the storage unit 420 to the renderer 141 in response to a report from, for example, the renderer 141 or the like.

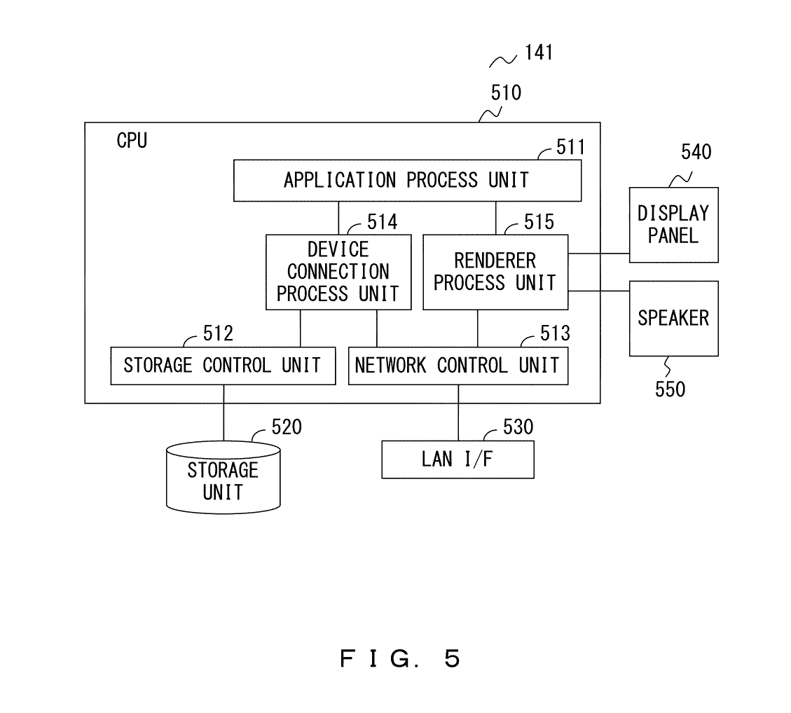

FIG. 5 illustrates an example of the renderer 141. The renderer 142 can be in a configuration similar to that of the renderer 141, and accordingly explanations of the renderer 142 will be omitted.

The renderer 141 may include a CPU 510, a storage unit 520, a LAN I/F 530, a display panel 540, and a speaker 550.

The CPU 510 maybe, for example, a processor. The CPU 510 controls constituents included in the renderer 141 so that the renderer 141 operates. Specifically, the CPU 510 realizes an application process unit 511, a storage control unit 512, a network control unit 513, a device connection process unit 514, a renderer process unit 515, etc., in accordance with a prescribed program.

The application process unit 511 may manipulate, for example, the storage control unit 512, the network control unit 513, the device connection process unit 514, the renderer process unit 515, and the like in accordance with a prescribed program included in application software. The storage control unit 512 writes data to and reads data from the storage unit 520 in response to a request made by the application process unit 511, the device connection process unit 514, and the like. The network control unit 513 transmits data to and receives data from a device in the home network 100 by using the LAN I/F 530. The device connection process unit 514 transmits data to and receives data from the controller 110 and the server 131, etc., in accordance with a prescribed protocol. For example, the device connection process unit 514 transmits and receives reproduction control information used for reproducing content to/from the controller 110. The renderer process unit 515 requests content for the server 131 in accordance with the request of the controller 110. Then, the renderer process unit 515 reproduces the content received from the server 131, and outputs images and audio to the display panel 540 and the speaker 550.

FIG. 6 illustrates an example of a configuration of a device information list 600 including device information according to the present example.

The device information list 600 is information in which a plurality of pieces of device information 610, 620, 630, . . . including device names, pieces of device-particular information, picked-up images, and pieces of mobile-device-particular information are associated in a form of list.

An example of device names is a name assigned to a device in the home network 100, e.g., the server 131, the renderer 141, etc. An example of device-particular information is information unique to a device such as a media access control (MAC) address or an Internet protocol (IP) address. A picked-up image is image data generated by picking up an image of a device. For mobile-device-particular information, information unique to the controller 110 that picked up an image of a device, e.g., a telephone number, an IP address, a MAC address, and the like can be used.

FIG. 7 illustrates an outline of a process of registering a device in the device information list 600. “(1)” through “(3)” in FIG. 7 correspond to “(1)” through “(3)” below. Also, it is assumed that the device names of the servers 131 and 132 are recorder1 and recorder2 and that the device names of the renderers 141 and 142 are TV1 and TV2.

(1) When the controller 110 has searched for a device in the home network 100, the controller 110 displays a device search result list window 710 on the display panel 340. Then, (2) it picks up an image of the renderer 142 after a user of the controller 110 selected a particular device, e.g., the renderer 142 in the device search result list window 710 in FIG. 7. Then, (3) the controller 110 registers device information including the device name obtained from the renderer 142 during the searching, e.g., “TV2” in the example of FIG. 7, device-particular information, a picked-up image of the renderer 142, and the mobile-device-particular information of the controller 110 that picked up the image of the renderer 142, at the tail of the device information list 600.

FIG. 8 is a flowchart illustrating an example of a process of registering device information in the device information list 600. In the example of FIG. 8, a case is illustrated as an example in which the servers 131 and 132 and the renderers 141 and 142 exist in the home network 100.

When a user of a smartphone, which functions as the controller 110, has executed a program that performs a registration process according to the present example, the controller 110 starts the following registration process.

First, the controller 110 transmits a device search message simultaneously to all devices existing in the home network 100 (step S801). For this device search message, a message including the servers 130 and the renderers 140 as device search targets can be used.

When the servers 130 and the renderers 140, which are device search targets among devices existing in the home network 100, have received the device search message, they transmit response messages to the controller 110 (step S802). In this case, each of the respective devices (the servers 131 and 132 and the renderers 141 and 142 in the example in FIG. 8) transmits to the controller 110 a response message including the device name and the device-particular information stored in the storage unit provided to the device.

Having received response messages in response to the device search message from the respective devices (step S802), the controller 110 obtains device names and device-particular information included in the response messages (step S803). Then, the controller 110 displays the device search result list window 710 exemplified in FIG. 7 on the display panel 340 for the servers 130 and the renderers 140 existing in the home network 100 (step S804).

When it is detected that a user has selected one device from among the servers 130 or the renderers 140 displayed in the device search result list window 710 of the display panel 340 (step S805), the controller 110 makes the process proceed to step S806.

When a user has specified a picked-up image registration of the device selected in step S806 (YES in step S806), the controller 110 activates the camera, and when the preparation of image pickup has been completed, the controller 110 reports the completion to the user by displaying the completion on the display panel 340 (step S307). When the image pickup process performed by the camera has been detected, the controller 110 makes the process proceed to step S808. When the user does not specify a picked-up image registration of the device (NO in step S806), the controller 110 makes the process proceed to step S808.

The controller 110 registers, in the device information list, device information in which device names and device-particular information obtained in step S803, mobile-device-particular information of the controller 110, and a picked-up image obtained in step S807 are associated for the devices selected in step S805.

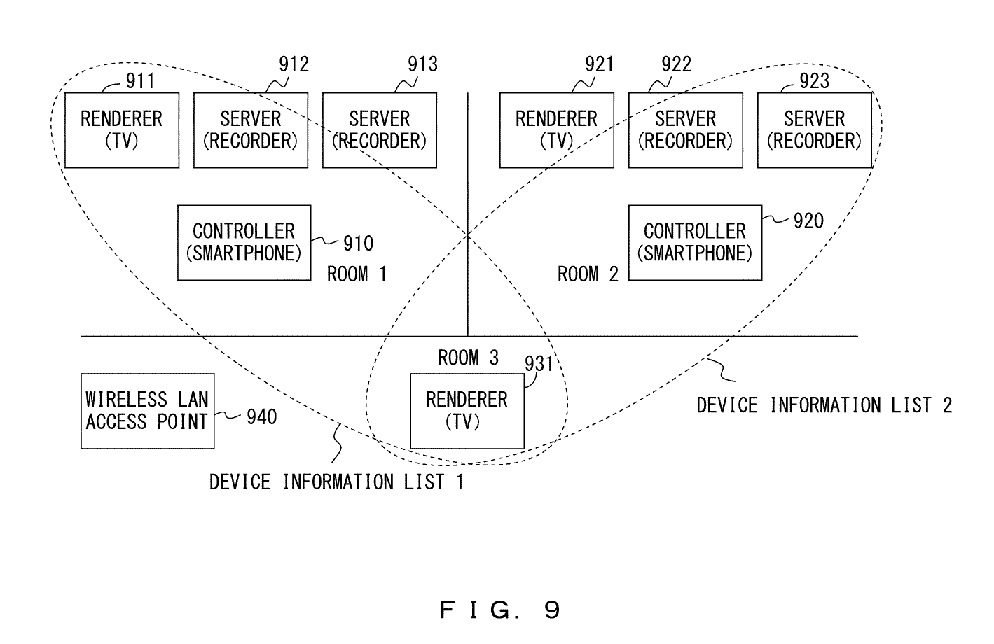

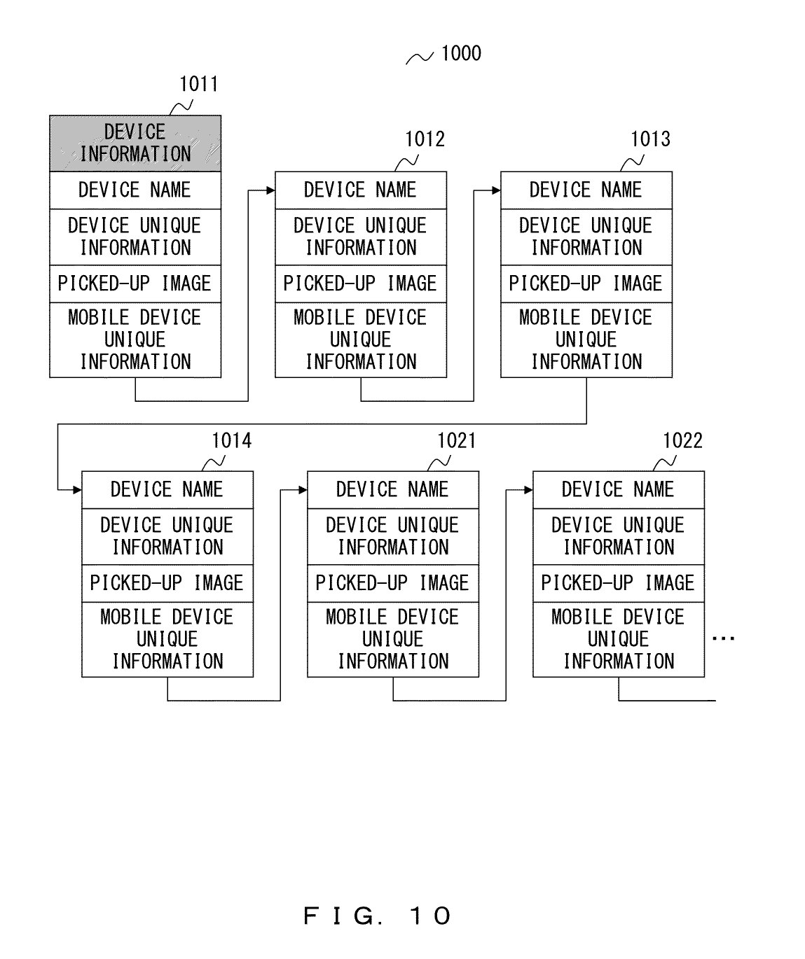

FIG. 9 and FIG. 10 explain application examples of the device information list 600.

FIG. 9 illustrates devices arranged in rooms 1 through 3. For example, a renderer 911 and servers 912 and 913 are arranged in room 1. A controller 910 in room 1 is the controller 110 used by user 1 in room 1. Also, renderer 921 and servers 922 and 923 are arranged in room 2. A controller 920 in room 2 is the controller 110 used by user 2 in room 2. In room 3, which is shared by users 1 and 2 of rooms 1 and 2, a renderer 931 is arranged. Although not illustrated, the renderers and servers arranged in the respective rooms are connected in a wired or wireless manner, and constitute a home network that allows mutual communications via a LAN cable or a wireless access point 940. Also, “(TV/PC)”, “(recorder)”, and “(smartphone)” in FIG. 9 are examples of devices. “TV/PC” represents a television or a display included in a PC.

In the example of FIG. 9, it is assumed that user 1 in room 1 registers the renderer 911 and the servers 912 and 913 arranged in room 1 and the renderer 931 arranged in room 3 in the device information list of the controller 910, which will hereinafter be referred to as device information list 1. It is also assumed that user 2 in room 2 registers the renderer 921 and the servers 922 and 923 arranged in room 2 and the renderer 931 arranged in room 3 in the device information list of the controller 920, which will hereinafter be referred to as device information list 2. Note that dashed lines in FIG. 9 do not represent device information lists but represent devices included in device information lists 1 and 2.

A case is now assumed as an example where user 1 is using the controller 910 for searching for a device in order to manipulate the device arranged in room 1 or 3. In such a case, the controller 910 transmits a device search message simultaneously to devices in the home network 100 in accordance with manipulation by the user 1. Then, the controller 910 extracts a device registered in device information list 1 of the controller 910 from among devices that received response messages in response to the device search message, and displays the extracted device in the device search result list window. In such a case, in the search result list window, only the device arranged in room 1 or 3 to be used by user 1 is displayed from among devices in the home network 100. As a result of this, user 1 can easily determine a desired device from among devices displayed in the device search result list window and use it.

Similarly, a case is assumed as an example where user 2 is using the controller 920 for searching for a device in order to manipulate the device arranged in room 2 or 3. In such a case, the controller 920 transmits a device search message simultaneously to devices in the home network 100 in accordance with manipulation by the user 2. Then, the controller 920 extracts a device registered in device information list 2 of the controller 920 from among devices that transmitted response messages in response to the device search message, and displays the extracted device in the device search result list window. In such a case, in the search result list window, only the device arranged in room 2 or 3 to be used by user 2 is displayed from among devices in the home network 100. As a result of this, user 2 can easily determine a desired device from among devices displayed in the device search result list window and use it.

As described above, device information lists 1 and 2 may independently be stored in the storage units of the controllers 910 and 920 and managed by the controller 910 and 920, respectively, and also may be stored in the storage unit of each of the controllers 910 and 920 so as to be shared by them.

FIG. 10 illustrates an example of a device information list 1000 when it is shared by the controllers 910 and 920.

FIG. 10 illustrates an example of the device information list 1000 in which device information list 1 including pieces of device information 1011 through 1014 and device information list 2 including pieces of device information 1021, 1022, . . . is associated in a listed manner. Pieces of device information 1011 through 1014 are pieces of device information of the renderer 911, the server 912, the server 913, and the renderer 931, respectively. Also, the pieces of device information 1021, 1022, . . . are pieces of device information of the renderer 921, the server 922, . . . , respectively.

Also, FIG. 10 illustrates an example of a case where device information list 1 and device information list 2 are associated in a listed manner as an example of the device information list 1000 when it is shared by the controller 910 and the controller 920; however, this is not intended to limit the scope of the present invention to the configuration illustrated in FIG. 10 as a matter of course. For example, when the device information list 1000 is to be shared by the controller 910 and the controller 920, it is sufficient when pieces of device information included in device information list 1 and pieces of device information included in device information list 2 are associated, and the order of associated pieces of device information, e.g., the order of pieces of device information connected in a listed manner, is not limited.

FIG. 11 illustrates an example of a process of sharing the device information list 1000 between the controllers 910 and 920.

When it is detected that user 1 has selected the export of device information list 1 by performing a prescribed manipulation after activating the controller 910 (step S1100a and step S1101a), the controller 910 refers to a storage unit in the controller 910. Then, the controller 910 reads device information list 1 stored in the referenced storage unit and generates export data from read device information list 1 so as to transfer the data to the controller specified by user 1, which is the controller 920 in the example of FIG. 11.

The controller 920 that has already been activated by user 2 (step S1100b), when receiving the export data from the controller 910 (step S1101b), makes the process proceed to step S1102b. In such a case, the controller 920 associates device information list 1 generated from the received export data with device information list 2 stored in the storage unit in the controller 920 in a listed manner (Step S1102b). In such a case, when there is a piece of device information that is in duplicate with that in device information list 2, the controller 920 may delete the piece of information in duplicate from the device information list 1 and connect it to device information list 2.

By performing the above processes, the controller 920 can share device information list 1 of the controller 910 with the controller 910. Also, when it is desired that the controller 910 share device information list 2 of the controller 920 with the controller 920, processes similar to the sharing process illustrated in FIG. 11 are performed and device information list 2 of the controller 920 is transferred to the controller 910.

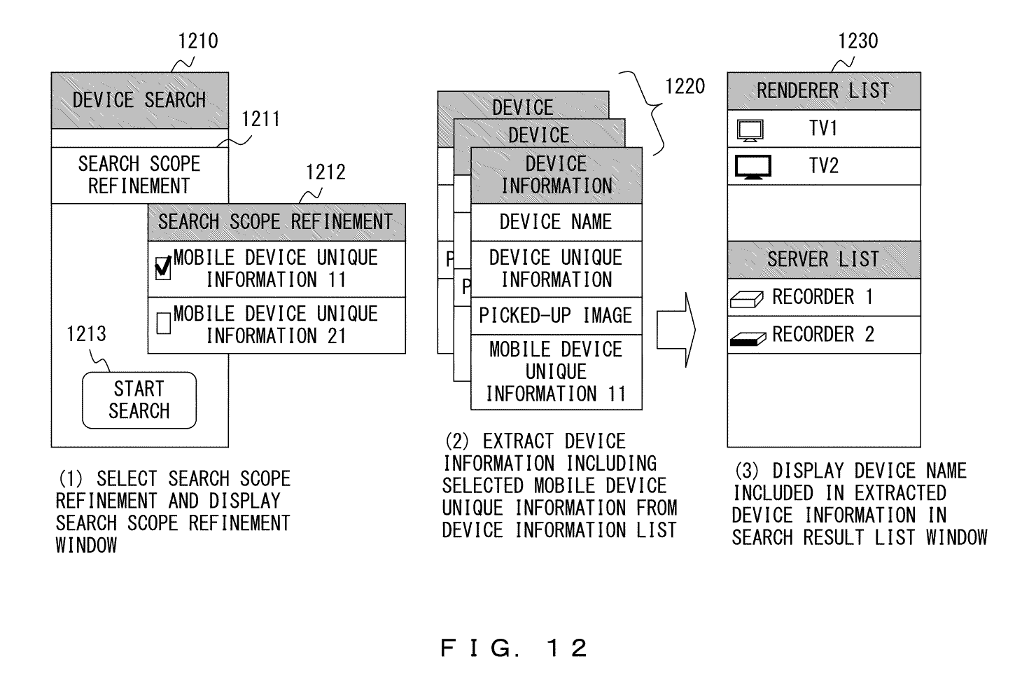

Next, an example of device searching by using mobile-device-particular information will be explained by referring to FIG. 12 and FIG. 13. In the explanations below, a case is exemplified where the storage unit 320 included in the controller 110 stores the device information list 1000 exemplified in FIG. 10.

FIG. 12 illustrates an outline of device searching that uses mobile-device-particular information. “(1)” through “(3)” in FIG. 12 correspond to (1) through (3) below.

(1) When, for example, a user has selected search-scope refinement 1211 from a device search window 1210 displayed on the display panel 340 by the controller 110, the controller 110 displays a search-scope refinement window 1212 on the display panel 340. The controller 110 displays, in the search scope refinement window 1212, a list of mobile-device-particular information included in the device information list 1000 stored in the storage unit 320 of the controller 110. In the example of FIG. 12, mobile-device-particular information 11 indicates the mobile-device-particular information of the controller 110 and mobile-device-particular information 21 indicates the mobile-device-particular information of a different controller.

(2) When the user has selected one of the pieces of mobile-device-particular information displayed in the search scope refinement window 1212 and selected a search start button 1213, the controller 110 extracts device information 1220 including the mobile-device-particular information selected by the user from among pieces of device information included in the device information list 1000.

Also, when the user has selected the search start button 1213 without selecting the search scope refinement 1211 in (1), the controller 110 may extract from the device information list 1000 the device information 1220 including the mobile-device-particular information 11 of the controller 110. Also, when the device information list 1000 includes only the mobile-device-particular information 11 of the controller 110, the controller 110 may extract the device information 1220 including the mobile-device-particular information 11 from the device information list 1000 without displaying the device search window 1210.

(3) Then, the controller 110 displays a device name included in the extracted device information 1220 in a search result list window 1230. A list of renderers and a list of servers may be displayed in the search result list window 1230. In the example of FIGS. 12, TV1 and TV2 are displayed as a list of renderers, and reorder 1 and recorder 2 are displayed as a list of servers.

FIG. 13 is a flowchart illustrating an example of a process of device search that uses mobile-device-particular information.

When a user of a smartphone, which functions as the controller 110, has executed a program of executing the device search process according to the present example, the controller 110 starts the following device search process.

The controller 110 displays the device search window 1210 on the display panel 340 (step S1301). When it is detected that a user has selected the search scope refinement 1211 displayed on the device search window 1210, the controller 110 displays the search scope refinement window 1212 on the display panel 340 (step S1302).

Then, when it is detected that the user has selected one of the pieces of mobile-device-particular information listed in the search scope refinement window 1212 (step S1303), the controller 110 makes the process proceed to step S1304. In such a case, the controller 110 transmits a device search message simultaneously to all devices in the home network 100 (step S1304). For this device search message, a message including the servers 130 and the renderers 140 as device search targets can be used.

When the server 130 and the renderer 140, which are the device search targets among devices existing in the home network 100, have received a device search message, they transmit response messages to the controller 110. In such a case, each device transmits to the controller 110 a response message including the device name and the device-particular information beforehand stored by the device in the storage unit. In the example in FIG. 13, a case is illustrated as an example where the servers 131 and 132 and the renderers 141 and 142 are in the home network 100.

When a response message is received from each device in response to a device search message (step S1305), the controller 110 obtains the device name and the device-particular information included in the response message (step S1306). Further, the controller 110 refers to the device information list 1000 stored by the controller 110 in the storage unit 320. Then, the controller 110 performs refinement of device information (step S1307) for extracting device information including the mobile-device-particular information selected by the user in step S1303 from among the pieces of device information obtained in step S1306. When mobile-device-particular information has not been selected in step S1303, the controller 110 may extract device information including the mobile-device-particular information of the controller 110 from among the pieces of device information obtained in step S1306.

Then, the controller 110 displays, in the search result list window 1230 in a selectable manner, the device names of the servers 130 and the renderers 140 included in the device information obtained as a result of the refinement performed in step S1307 (step S1308). When it is detected that a user has selected one of the devices displayed in the search result list window 1230, the controller 110 obtains the device name selected by the user (step S1309). For example, when the user has selected a renderer, the controller 110 can execute, for example, a process of content search, which will be explained in FIG. 15A and FIG. 15B. When the user has selected a recorder, the controller 110 may provide a manipulation desired by the user such as timer recording or the like in accordance with the specification of the DLNA guidelines for the recorder selected by the user, although this is not described in the present example.

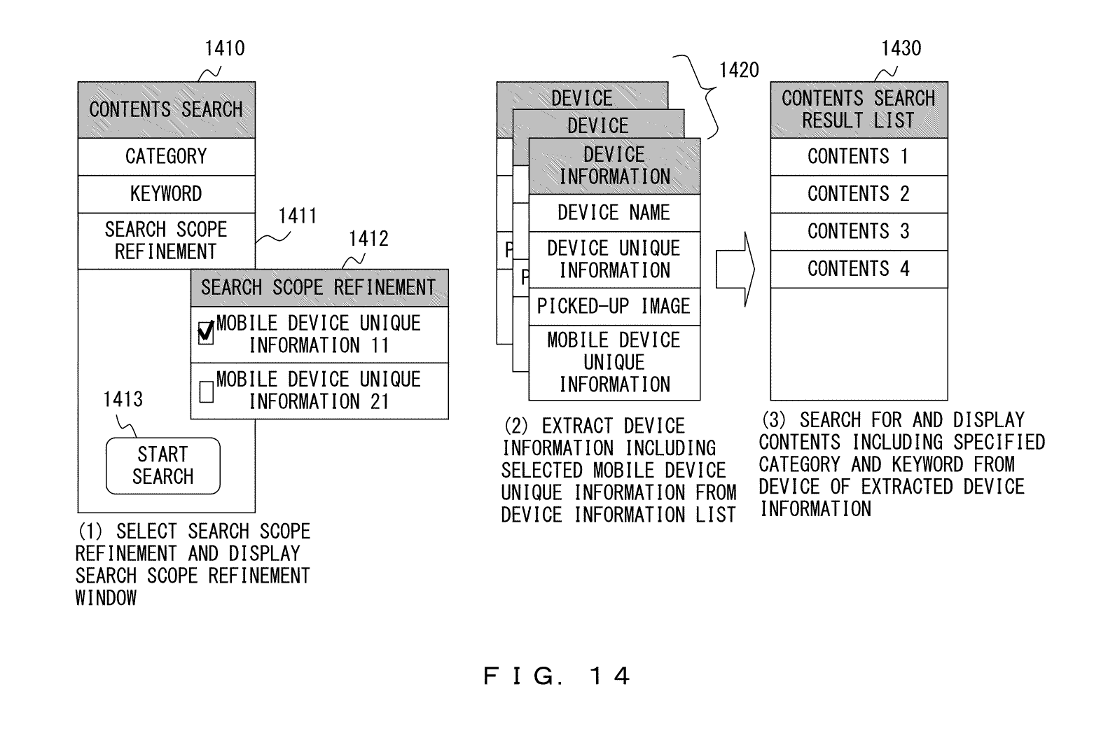

Next, an example of content search that uses mobile-device-particular information will be explained by referring to FIG. 14, FIG. 15A and FIG. 15B. In the explanations below, a case is described as an example where the storage unit 320 included in the controller 110 stores the device information list 1000 exemplified in FIG. 10.

FIG. 14 illustrates an outline of content search that uses mobile-device-particular information. “(1)” through “(3)” in FIG. 14 correspond to (1) through (3) below.

(1) The controller 110 displays a content search window 1410 on the display panel 340. The content search window 1410 may include an edit box for inputting a category or keyword of desired content. When for example a user has selected search scope refinement 1411 from the content search window 1410 being displayed by the controller 110 on the display panel 340, the controller 110 displays a search scope refinement window 1412 on the display panel 340. The controller 110 displays on the search scope refinement window 1412 a list of pieces of mobile-device-particular information included in the device information list 1000 stored in the storage unit 320 of the controller 110. In the example of FIG. 14, the mobile-device-particular information 11 indicates pieces of the mobile-device-particular information of the controller 110 and the mobile-device-particular information 21 indicates pieces of mobile-device-particular information of other controllers.

(2) When a user has selected a search start button 1413 after selecting one of the pieces of mobile-device-particular information displayed in the search scope refinement window 1412, the controller 110 extracts device information 1420 including the piece of mobile-device-particular information selected by the user from among pieces of device information included in the device information list 1000.

When the user has selected the search start button 1413 without selecting the search scope refinement 1411 in (1), the controller 110 may extract the device information 1420 including the mobile-device-particular information 11 of the controller 110 from the device information list 1000. Also, when the device information list 1000 only includes the mobile-device-particular information 11 of the controller 110, the controller 110 may extract the device information 1420 including the mobile-device-particular information 11 from the device information list 1000 without displaying the content search window 1410.

Then, the controller 110 searches, for content including the category or the keyword specified in the content search window 1410, the devices of the extracted one or more pieces of device information 1420, and displays the obtained content in a content search result list window 1430.

FIG. 15A and FIG. 15B are flowcharts illustrating an example of a process of content search that uses mobile-device-particular information.

When a user of a smartphone, which functions as the controller 110, has executed the program for performing the content search process according to the present example, the controller 110 starts the following content search process.

The controller 110 displays the content search window 1410 on the display panel 340 (step S1501). When input of a category, a keyword, or the like by the user has been detected, the controller 110 obtains the input category, keyword, or the like as a content search condition (step S1502).

When it is detected that the user has selected the search scope refinement 1411 displayed in the content search window 1410, the controller 110 displays the search scope refinement window 1412 on the display panel 340 (step S1503).

When it is detected that the user has selected one of the pieces of mobile-device-particular information displayed in the search scope refinement window 1412 (step S1504), the controller 110 makes the process proceed to step S1505. In such a case, the controller 110 transmits a device search message simultaneously to all devices in the home network 100 (step S1505). For this device search message, a message including the server 130 as the device search target maybe used.

When the server 130 as a device search target among devices in the home network 100 has received a device search message, it transmits a response message to the controller 110. In such a case, each device transmits to the controller 110 a response message including the device name and the device-particular information stored by the device in the storage unit. In the example in FIG. 15A and FIG. 15B, a case is explained where the servers 131 and 132 and the renderers 141 and 142 exist in the home network 100.

When a response message in response to a device search message has been received from each device (step S1506), the controller 110 obtains the device name and the device-particular information included in the response message (step S1507). Further, the controller 110 refers to the device information list 1000 stored in the storage unit 320 of the controller 110. Then, the controller 110 performs refinement of device information to be extracted for servers including the mobile-device-particular information selected by the user in step S1504 from among the pieces of device information including the device-particular information obtained in step S1507 (step S1508). When mobile-device-particular information has not selected in step S1504, the controller 110 may extract device information including the mobile-device-particular information of the controller 110 from among pieces of device information for the server including the device-particular information obtained in step S1507.

The controller 110 requests, from the server of the device information extracted in step S1508, pieces of information about content stored in the server, e.g., content information including titles, categories, and abstracts of the content (step S1509). When the content information has been received from the server, the controller 110 checks the content information with the content search conditions obtained in step S1502 (step S1510). Then, the controller 110 stores in the storage unit 320 the content information including the content search conditions obtained in step S1502, e.g., the content information including categories and keywords. The processes in step S1509 through step S1511 are repeated for all servers of the device information extracted in step S1508 (NO in step S1511).

When the processes of step S1509 through step S1511 are performed for all servers in the device information extracted in step S1508 (YES instep S1511), the controller 110 makes the process proceed to step S1412. In such a case, the controller 110 displays the content obtained in the processes of step S1509 through step S1511 in the content search result list window 1430 (step S1512).

When it is detected that a user has selected one of the content displayed in the content search result list window 1430 (step S1513), the controller 110 instructs the renderer selected by the user in step S1309 in, for example, FIG. 13 to reproduce the content selected by the user (step S1514). Also, the process in step S1514 is similar to the processes in step S1712 through 1714, which will be described in, for example, FIG. 17A and FIG. 17B.

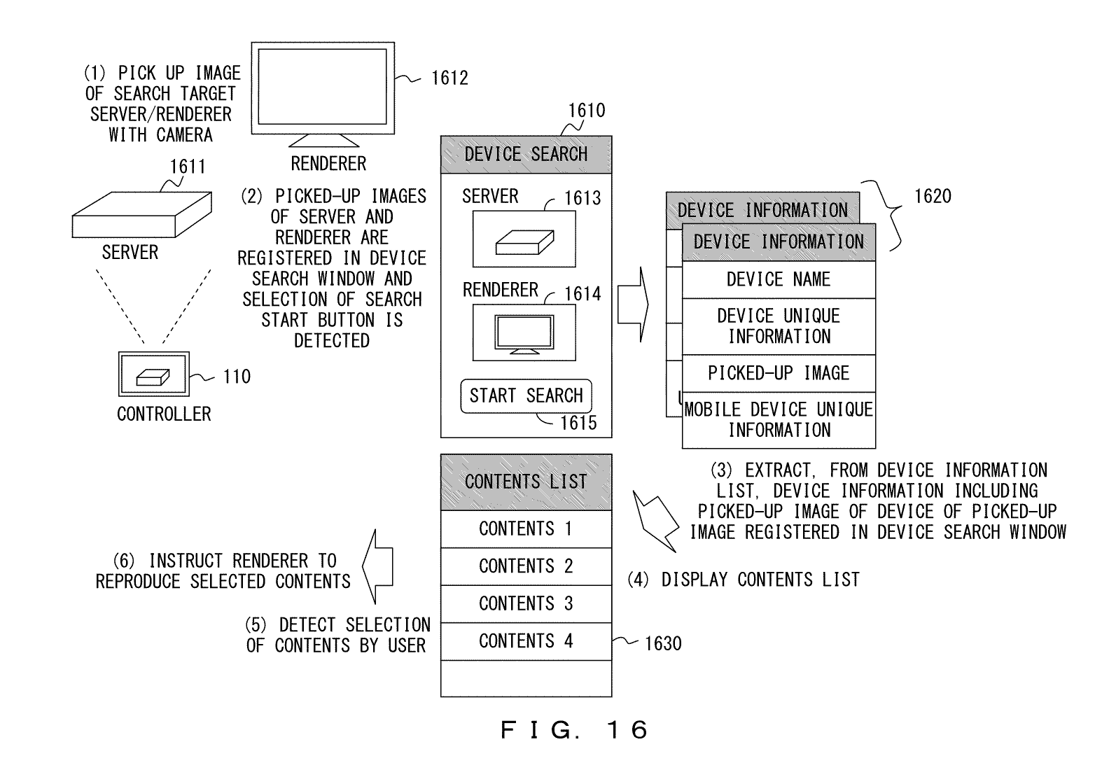

FIG. 16, FIG. 17A, and FIG. 17B illustrate an example of a process of performing device search and content reproduction by using an image picked up by a camera.

FIG. 16 illustrates an outline of a process of performing device search and content reproduction by using an image picked up by a camera. “(1)” through “(6)” in FIG. 16 correspond to “(1)” through “(6)” below.

(1) In response to, for example, a prescribed manipulation performed by a user, the controller 110 picks up an image of a server 1611 and a renderer 1612 as search targets by using a camera.

(2) The controller 110 detects that the user has registered picked-up images 1613 and 1614 of the server 1611 and the renderer 1612 in a device search window 1610 and has selected a search start button 1615.

(3) Then, the controller 110 refers to the device information list 600 stored in the storage unit 320 of the controller 110, and extracts device information 1620 including the picked-up images of the devices of the registered picked-up images 1613 and 1614. The controller 110 can recognize from the extracted device information 1620 that the registered picked-up images 1613 and 1614 are the server 1611 and the renderer 1612.

(4) Then, the controller 110 requests content information from the server 1611, and displays the content included in the content information received from the server 1611 in a content list window 1630 in a selectable manner.

(5) When it is detected that the user has selected one of the content displayed in the content list window 1630, (6) the controller 110 instructs the renderer 1612 to reproduce the content selected by the user. In such a case, the renderer 1612 that has received the instruction receives the content specified by the controller 110 from the server 1611, and reproduces it.

FIG. 17A and FIG. 17B are flowcharts illustrating an example of a process of performing device search and content reproduction by using an image picked up by using a camera.

When a user of a smartphone which functions as the controller 110 has executed the program for performing the device search and content reproduction according to the present example, the controller 110 starts the following process.

When it is detected that a user has registered in the device search window 1610 images of a server and a renderer picked up by using a camera (step S1701), the controller 110 obtains the registered picked-up images (step S1702 and step S1703).

The controller 110 refers to the device information list 600 stored in the storage unit 320 of the controller 110, and searches for device information including picked-up images identical to the picked-up images obtained in step S1702 and step S1703 (step S1704). Thereby, the controller 110 can determine the server and the renderer to be used in processes to be executed later. Hereinafter, the server determined in the process in step S1704 is referred to as a “determined server”, and the renderer determined in the process in step S1704 is referred to as a “determined renderer”.

The controller 110 can determine whether or not the picked-up image obtained in step S1702 and step S1703 and the picked-up image included in the device information of the device information list 600 are identical to each other on the basis of outlines and background colors extracted from those picked-up images. In such a case, when the degree to which the outlines are identical and the degree to which the background colors are identical are equal to or higher than prescribed values, respectively, the controller 110 can determine that these images are identical. It is also possible to use a known different process for the process of determining whether or not images are identical.

When the server and the renderer are determined, the controller 110 transmits a device search message simultaneously to all devices in the home network 100 (step S1704). For this device search message, a message including the server 130 and the renderer 140 as device search targets may be used.

When a device search message has been received, the server and the renderer that are device search targets from among devices in the home network 100 transmit response messages to the controller 110 (step S1705). In such a case, each device transmits to the controller 110 a response message including the device name and the device-particular information that the device has stored in the storage unit beforehand. In the example of FIG. 17A and FIG. 17B, an example is illustrated where the servers 131 and 132, and the renderers 141 and 142 are in the home network 100.

When a response message in response to the device search message has been received from the respective devices (step S1706), the controller 110 obtains device information such as the device name and the device-particular information included in the response message (step S1707).

When the device information obtained in step S1707 includes the device information of the determined server and the determined renderer (YES in step S1708), the controller 110 determines that the determined server and the determined renderer exist in the home network 100, and makes the process proceed to step S1709. In such a case, the controller 110 makes a request to the determined server for content information so as to obtain, from the determined server, content information including information related to the content stored in the determined server (step S1709).

When the device information obtained in step S1707 does not include the device information of the determined server or the determined renderer (NO in step S1708), the controller 110 displays a prescribed message so as to perform abnormal termination (step S1715).

When content information has been received from the determined server (step S1709), the controller 110 displays the content included in the received content information in the content list window 1630 in a selectable manner (step S1710).

When it is detected that a user has selected one of the pieces of content displayed in the content list window 1630 (step S1711), the controller 110 instructs the determined renderer, that is, the renderer 141 in the example of FIG. 17A and FIG. 17B, to reproduce the selected content (step S1712).

The determined renderer having received the reproduction instruction requests the content from the determined server that were reported together with the reproduction instruction, that is, from the server 131 in the example of FIG. 17A and FIG. 17B (step S1713). When the reception of the content from the determined server has been completed, the determined renderer reproduces the received content (step S1714).

As described above, the controller 110 detects devices in the home network 100 from response messages in response to a device search message transmitted simultaneously to all devices in the home network 100 (step S1306). Then, the controller 110 displays, in the search result list window 1230, only devices whose device information has been registered in the device information list 600 stored in the storage unit 320 of the controller 110 from among devices in the home network 100 (step S1307 and step S1308).

Accordingly, when a user has registered device information of a device to be used by the user in the device information list 600, the user can determine the device to be used by the user easily in the search result list window 1230. As a result of this, according to the controller 110, it is possible for a user to determine and manipulate a desired device from a device in the home network 100 easily.

Also, from among servers 130 existing in the home network 100, the controller 110 displays the content search result list window 1430 by obtaining content information only from the server 130 whose device information has been registered in the device information list 600 stored in the storage unit 320 of the controller 110 (step S1507, step S1508, and step S1512).

Accordingly, when a user has registered device information of the server 130 to be used by the user in the device information list 600 in advance, the user can easily perform a manipulation such as reproduction by selecting desired content stored in the server 130 to be used by the user in the content search result list window 1430.

Also, the controller 110 determines the server 130 and the renderer 140 desired by the user on the basis of comparison between an image picked up by the user and a picked-up image included in the device information in the device information list 600 beforehand stored in the storage unit 320 of the controller 110 (step S1704). Then, the controller 110 displays it in a content list window 1630 stored in the determined server 130 (step S1709 and step S1710). As a result of this, when a user has registered the device information about the server 130 to be used by the user in the device information list 600 in advance, the user can easily obtain the content list window 1630 of the content included in the server 130 by picking up an image of the server 130 and registering it in the device search window 1610. Further, when the user has selected desired content in the content list window 1630, the controller 110 reproduces the selected content by using the determined renderer 140. As described above, the user can easily select desired content stored in, for example, the server 130 existing in front of the user and perform a manipulation such as reproduction or the like.

Also, the device information list 1000 can store device information in association with the mobile-device-particular information of the controller to be used by a user. In such a case, the device information list 1000 of the controller 110 for example can include device information associated with the mobile-device-particular information of the controller 110 (for example the mobile-device-particular information 11 illustrated in FIG. 10) and mobile-device-particular information of a different controller (for example, the mobile-device-particular information 21 illustrated in FIG. 10). Accordingly, the controller 110 and a different controller can share the device information list 1000.

When a device information list is to be shared by a different controller by using the device information list 1000, the controller 110 can extract only a device that is associated with the controller whose device information has been registered in the device information list 1000 and which is specified by the user from among devices in the home network 100 (step S1303 through 1307 and step S1504 through step S1508). As a result of this, when a user has registered the device information of a device to be used by the user in the device information list 1000, the user can easily determine and manipulate the device to be used by the user by using an arbitrary controller that shares the device information list 1000.

Also, because the device information list 1000 can store device information in association with mobile-device-particular information of controllers, a plurality of different controllers can each manage the same device to be shared by associating the device with their pieces of mobile-device-particular information.

As described above, according to the controller 110, it is possible to determine and manipulate a desired device from among devices in the home network 100 easily.

As described above, in one aspect, a control device according to the embodiments can provide a control device that can easily determine and manipulate a desired device from among devices in a network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control device that controls devices in a network, the control device comprising:
a storage unit configured to store registration information in which one or more pieces of identification information that identifies a device as a control target from among devices in the network are registered beforehand; and
a processor configured to execute a process including:
detecting devices in the network from a response message in response to a device search message transmitted simultaneously to devices in the network and to extract a device whose identification information is registered in the registration information from among the detected devices;
displaying the extracted device in a display device in a selectable manner; and
performing a prescribed manipulation on a selected device when the processor detects that a user has selected one of the devices displayed in the display device.

2. The control device according to claim 1, wherein:
the identification information includes a picked-up image of a device corresponding to the identification information; and
the detecting detects devices in the network from a response message in response to a device search message transmitted simultaneously to devices in the network and extracts, from among the detected devices, a device of identification information whose picked-up image of a device identical to a device corresponding to an image picked up as a search target by a user is registered in the registration information.

3. The control device according to claim 1, wherein:
the displaying obtains, from a first device from among the extracted device, information about content stored in the first device, and displays a list of content in the display device; and
the performing instructs a second device from among the extracted device to reproduce content selected by the user in a list of content displayed in the display device.

4. The control device according to claim 1, wherein:
identification information that identifies one or more devices from among devices in the network is registered beforehand in association with a control device that manages the one or more devices in the registration information.

5. The control device according to claim 4, wherein:
the detecting detects devices in the network from a response message in response to a device search message transmitted simultaneously to devices in the network and extracts a device whose identification information that is associated with a control device specified by a user from among the detected devices is registered in the registration information.

6. The control device according to claim 1, wherein:
devices in the network each include a function based on a specification of DLNA (Digital Living Network Alliance) guidelines.

7. The control device according to claim 1, wherein:
the control device includes a function based on a specification of DLNA (Digital Living Network Alliance) guidelines.

8. A control method for controlling devices in a network, the control method comprising:
reading from a storage device by a processor, registration information in which one or more pieces of identification information that identifies a device as a control target from among devices in the network are registered beforehand;
detecting devices in the network from a response message in response to a device search message and extracting a device by the processor, the device search message being transmitted simultaneously to devices in the network, identification information of the extracted device being registered in the registration information from among the detected devices;
displaying the extracted device in a display device in a selectable manner; and
performing a prescribed manipulation on a selected device by the processor when the processor detects that a user selected one of the devices displayed in the display device.

9. A computer-readable recording medium having stored therein a program for causing a computer to execute a process for controlling devices in a network, the process comprising:
reading, from a storage device, registration information in which one or more pieces of identification information that identifies a device as a control target from among devices in the network are registered beforehand;
detecting devices existing in the network from a response message in response to a device search message that was transmitted simultaneously to devices in the network, and extracting a device whose identification information is registered in the registration information from among the detected devices;
displaying the extracted device in a display device in a selectable manner; and
performing a prescribed manipulation on a selected device when the computer detects that a user selected one of the devices displayed in the display device.
